(19) United States
(12) Patent Application Publication
(10) Pub. No.: US 2024/0373813 A1
(43) Pub. Date: Nov. 14, 2024

(54) ANIMAL FENCE AND METHOD OF ASSEMBLING THE SAME

(71) Applicant: L.T. HAMPEL CORP., Germantown, WI (US)

(72) Inventor: Lance T. Hampel, Germantown, WI (US)

(21) Appl. No.: 18/554,142

(22) PCT Filed: Apr. 6, 2022
(86) PCT No.: PCT/US2022/023701

§ 371 Date: Oct. 5, 2023

Related U.S. Application Data
(60) Provisional application No. 63/171,528, filed on Apr. 6, 2021.

(51) Int. Cl. A01K 1/00; E04H 17/00; E04H 17/16; E04H 17/18

(52) U.S. Cl. CPC A01K 1/0017; A01K 1/0088; E04H 17/013; E04H 17/161; E04H 17/185

(57) ABSTRACT

A method of assembling a fence unit, where the method includes providing a side panel and a door frame of a fence assembly, where the side panel includes a plurality of vertical wires and a plurality of horizontal wires, and where the door frame including a side hook and side loop, sliding one of the plurality of vertical wires of the side into the side hook of the door frame, rotating the side panel with respect to the door frame such that the side loop of the door frame protrudes through a plane defined by the side panel, and inserting a door frame engagement pin through the side loop, where the door frame engagement pin includes an elongated portion and a fastening portion, and wherein, once inserted, the elongated portion engages at least one of the plurality of horizontal wires of the side panel to prevent the side panel from rotating with respect to the door frame.

### CROSS-REFERENCE TO RELATED APPLICATIONS

This application claims priority to U.S. Provisional Patent Application No. 63/171,528, filed Apr. 6, 2021, the entire contents of which is hereby incorporated by reference.

### FIELD OF THE INVENTION

The present invention relates to housing units for animals.

### BACKGROUND

Farm animals often live in housing units that provide shelter and a space for the animal to move around. For example, calves may live in individual housing units with shelters (e.g., hutches) and with fences surrounding a yard in front of the hutch. The calves may roam between the hutch and the yard.

### SUMMARY

In at least one embodiment, the present disclosure provides a method of assembling a fence unit, where the method includes providing a side panel and a door frame of a fence assembly, where the side panel includes a plurality of vertical wires and a plurality of horizontal wires, and where the door frame including a side hook and side loop, sliding one of the plurality of vertical wires of the side into the side hook of the door frame, rotating the side panel with respect to the door frame such that the side loop of the door frame protrudes through a plane defined by the side panel, and inserting a door frame engagement pin through the side loop, where the door frame engagement pin includes an elongated portion and a fastening portion, and wherein, once inserted, the elongated portion engages at least one of the plurality of horizontal wires of the side panel to prevent the side panel from rotating with respect to the door frame.

In at least one embodiment, the present disclosure provides a front gate for a modular animal enclosure including a door frame including a first laterally outermost vertical wire or framing bar, a door disposed in the door frame, a first set of one or more side hooks disposed on the first laterally outermost vertical wire or framing bar, and a first set of one or more side loops disposed on the first laterally outermost vertical wire or framing bar, wherein the first set of one or more side hooks are configured to engage a linking vertical wire of a side panel, the side panel including a plurality of horizontal wires and plurality of vertical wires, and wherein the first set side loops are configured to protrude through a plane defined by the plurality of horizontal wires and plurality of vertical wires.

In at least one embodiment, the present disclosure provides a connection panel configured to connect a first door frame and a second door frame, where the connection panel includes a body, a side hook aperture disposed in the body and configured to accommodate a side hook of a door frame, a stand portion disposed proximate the bottom of the body and extending therefrom, the stand portion configured to support the body in a vertical orientation relative to a ground surface and at least one finger disposed on a back side of the body, where the finger is configured to engage a horizontal wire or a horizontal bar of the door frame.

Other aspects of the invention will become apparent by consideration of the detailed description and accompanying drawings.

### BRIEF DESCRIPTION OF THE DRAWINGS

FIG. 1 is a perspective view of a housing system according to one embodiment with a perimeter fence including a door and door frame assembly connected to wire side panels, the door held closed by a guillotine latch.

FIG. 2 illustrates a vertical wire of a side panel being slid horizontally into a side hook of a door frame such that the vertical wire of the side panel may be partially, mechanically retained in the side hook to the door frame.

FIG. 3 illustrates a vertical wire of the side panel partially, mechanically retained in the side hook to the door frame in a vertical plane parallel to a vertical plane defined by the door frame.

FIG. 4 illustrates a vertical wire of the side panel partially, mechanically retained in the side hook to the door frame in a vertical plane perpendicular to a vertical plane defined by the door frame.

FIG. 5 is a perspective view of the side panel slid into and rotated within a side hook of the door frame such that the side panel is partially, mechanically retained in the side hook, and a side loop of the door frame protrudes through an opening in the side panel.

FIG. 6 is a side view of an door frame engagement pin.

FIG. 7 illustrates a door frame engagement pin being slid vertically into the side loop of the door frame and mechanically bracing the side panel such that the side panel is fully locked into the perpendicular position by the side hook, the door frame, and the door frame engagement pin.

FIG. 8 illustrates the door frame engagement pin clipped unto the top of the side panel.

FIG. 9 is a perspective view of the door, door frame, and side panel interconnected in a, perpendicular configuration and a bar latch disposed on the door frame, the bar latch posed in an open position.

FIG. 10 illustrates the perimeter fence of the housing system in a transport configuration, the perimeter fence comprising a door frame with door, assembled with side panels.

FIG. 11 is a perspective view of a heavy duty side hook of a heavy duty door frame.

FIG. 12 is a perspective view of a vertical wire of the side panel partially, mechanically retained in the heavy duty side hook to the heavy duty door frame in a vertical plane perpendicular to a vertical plane defined by the heavy duty door frame.

FIG. 13 illustrates an assembly door frame engagement pin being slid vertically into the side loop of the door frame and mechanically bracing the side panel such that the side panel is locked into a perpendicular position by the heavy duty side hook, the heavy duty door frame, and the door frame engagement pin.

FIG. 14 is a perspective view of a connection panel.

FIG. 15 is another perspective view of the connection panel.

FIG. 16 illustrates, from a first perspective, the connection panel connecting the two front panels together end to end and keeping them in an interconnected side-by-side arrangement.

FIG. 17 illustrates, from a second perspective, the connection panel connecting the two front panels together end to end and keeping them in an interconnected side-by-side arrangement.

FIG. 18 illustrates a perspective view of a second connection panel.

FIG. 19 illustrates from a first perspective, the second connection panel connecting the two front panels together end to end and keeping them in an interconnected side-by-side arrangement

FIG. 20 illustrates from a second perspective, the second connection panel connecting the two front panels together end to end and keeping them in an interconnected side-by-side arrangement

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

Farm animals, especially adolescent farm animals may be raised in semi-portable enclosures having a perimeter fence and a yard for the animals to roam. Often times, these enclosures are not modular, which leads to issues in shipping or transporting the enclosures. A method for modularly connecting parts of an animal enclosure is disclosed. The present disclosure is filed alongside a related application stemming from U.S. Provisional Patent Application No. 63/171,545, filed Apr. 6, 2021, the entire contexts of which is hereby incorporated by reference.

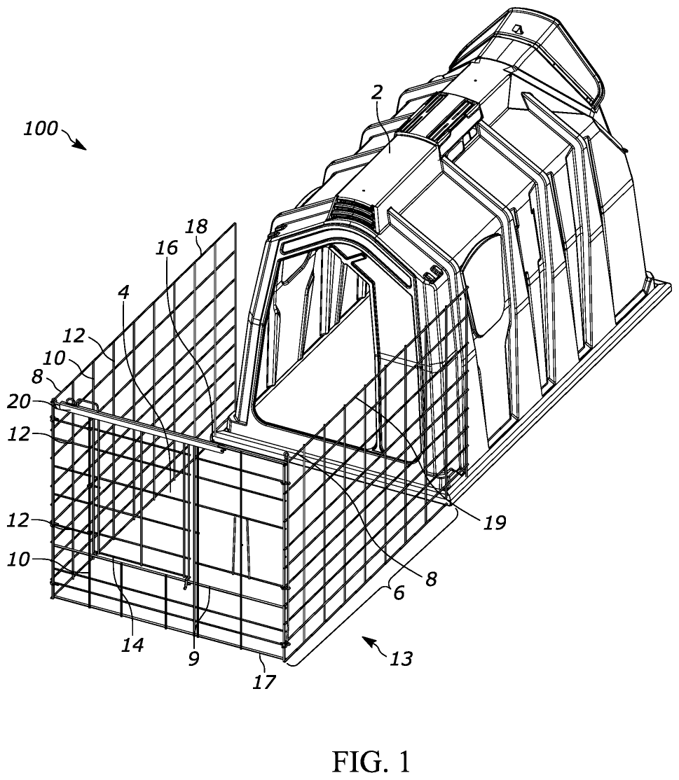

FIG. 1 illustrates an embodiment of an animal housing system 100. The animal housing system 100 includes a hutch 2, and a yard 4 enclosed by a perimeter fence 6. The perimeter fence 6 includes two side panels 8 and front gate 13 extending between the two side panes 8 to form a U-shape. The front gate 13 includes a door 14 and door frame 9 assembly supporting the door 14. One or both of the door 14 and the door frame 9 may be formed of wire. For example, in the illustrated embodiment, the side panels 8 and the door frame 9 comprise a number of vertical wires 10 and horizontal wires 12 positioned in a mesh pattern and joined (e.g. welded) together to form a fence. The horizontal wires 12 of both the door frame 9 and the side panels 8 may be positioned closer together near the bottoms of both the door frame 9 and the side panels 8, as compared to near the tops of both the door frame 9 and side panels 8, to prevent small animals from passing any part of their body through the mesh formed by the horizontal wires 12 and vertical wires 10 of the side panels 8 and door frame 9. For example, the vertical spacing of the horizontal wires 12 of the door frame 9 and the side panels 8 may be 6 inches on the top halves of each of the door frame 9 and the side panels 8, while the vertical spacing of the horizontal wires 12 of the door frame 9 and the side panels 8 may be 2 or 3 inches on the bottom halves.

When the door 14 is in a closed position, the door 14 and door frame 9 together define and lie within a vertical plane running through both a bottom horizontal wire 17 of the door frame 9 and a top horizontal wire (not shown) of the door 14. Similarly, each side panel 8 defines and lies within a vertical plane defined by a top horizontal wire 18 of the side panel 8 and a bottom horizontal wire 16 of the side panel 8. The door frame 9 is connected to the two side panel 8, which meet the edges of the door frame 9 at an angle perpendicular to the vertical plane defined by the door 14 and door frame 9. In the embodiment shown, the front gate 13 is removably coupled to the two side panels 8. This enables the front gate 13 and/or the side panels 8 to be selectively removed or replaced.

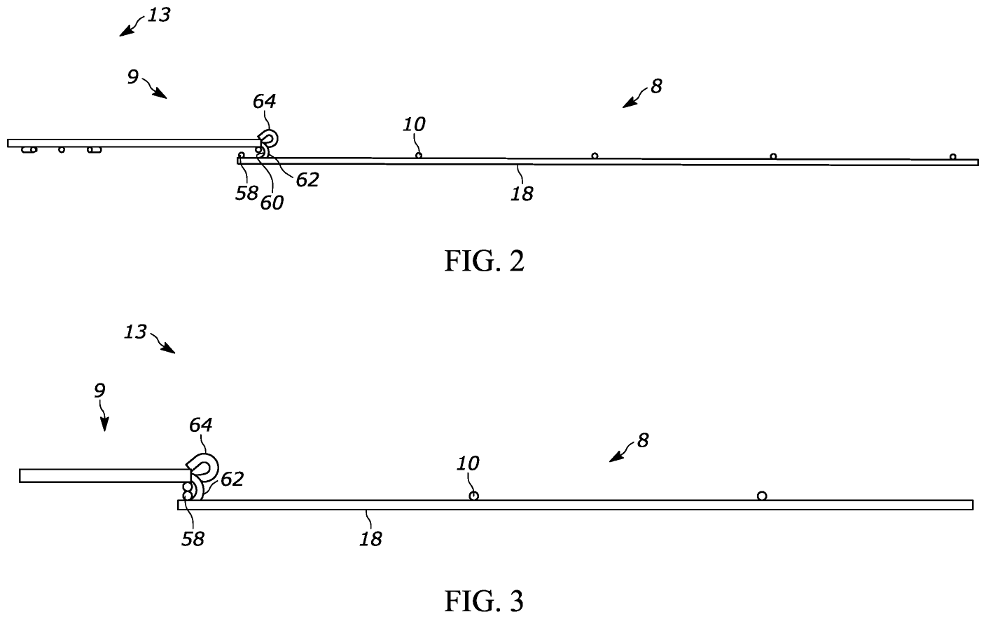

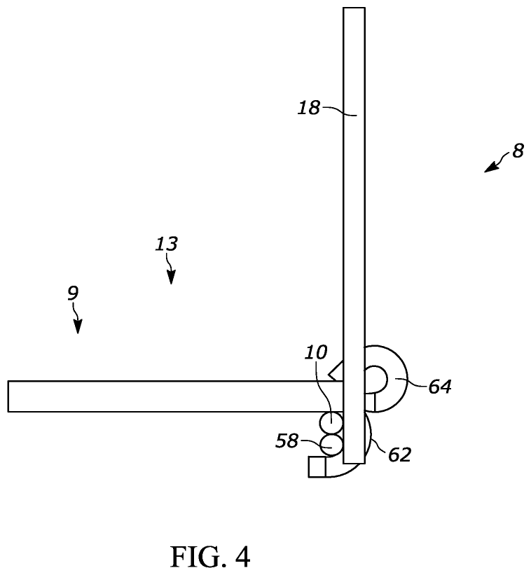

FIGS. 2-4 illustrate a sliding and rotating engagement between the front gate 13 and a side panel 8. In FIG. 2, the side panel 8 is shown as aligned with the door frame 9 in an overlapping parallel configuration. A linking vertical wire 58 at an extremity (e.g. an outermost lateral position) of the side panel 8 is laterally aligned with a concave portion 60 of a side hook 62 at an extremity of the door frame 9 (e.g., at a laterally outermost vertical wire of the door frame 9). In FIG. 3, the linking vertical wire 58 of the side panel 8 is shown as slid (towards the right as shown in FIG. 3) into the concave portion 60 of the side hook 62 and retained in a paired configuration with a vertical wire 10 of the door frame 9. In other embodiments, the linking vertical wire 58 may not be paired with the vertical wire 10 of the door frame 9. For example, the vertical wire 58 may be received within the side hook 62 while the vertical wire 10 is positioned outside of the side hook 62. FIG. 4 shows the side panel 8 rotated (e.g., counterclockwise in FIG. 4) relative to the front gate 13. Specifically, the side panel 8 is shown as rotated with respect to the door frame 9 such that a side loop 64 at an extremity of the door frame 9 protrudes through an opening in the side panel 8. In other words, the side loop 64 extends beyond the plane defined by the side panel 8. Accordingly, the linking vertical wire 58 may be slid into engagement with the side hook 62 and then at least partially, rotatably retained in the concave portion 60 of the side hook 62.

This allows the front gate 13 to be removeable coupled to the side panel 8 by sliding the front gate 13 laterally (i.e., in a first direction) relative to the side panel 8, and then rotating the front gate 13 (i.e., in a second direction) relative to the side panel 8. As will be understood, the lateral and rotational movement may also be done by the panel 8 relative to the front gate 13. The first direction may be identified by the plane defined by the front gate 13. The second direction may be defined by a rotational axis extending parallel to the plane.

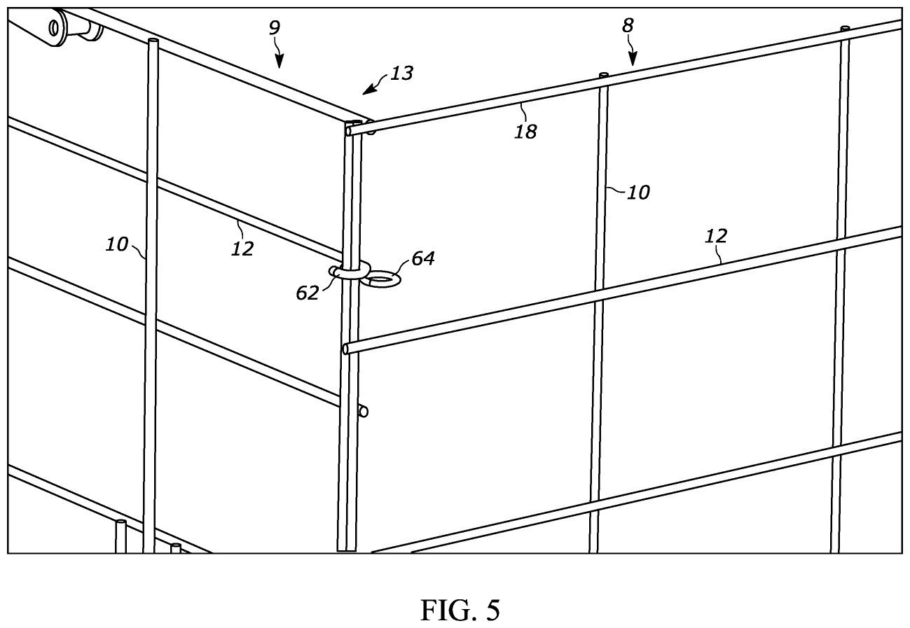

FIG. 5 is a perspective view of the door frame 9 and side panel 8 engaged, as a result of the sliding engagement, and rotated at an angle with respect to one another. As shown, the side loop 64 may be attached to or part of a horizontal wire 12 of the door frame 9 and adjacent to the side hook 62. However, in other embodiments, the hook 62 may be a separate element from the horizontal wires 12 of the door frame 9. Likewise, the side loop 64 may be an extension of one of the horizontal wires 12, or may be a separate element. Furthermore, the hook 62 and side loop 64 may have other configurations or may be positioned at a vertical distance from one another. However, as will be appreciated from the description below, the side loop 64 and the side hook 62 should be disposed in a spatial relationship that will facilitate a locking of the side panel 8 at a maximum angular rotation with respect to the door frame 9 by use of a door frame engagement pin, as described herein.

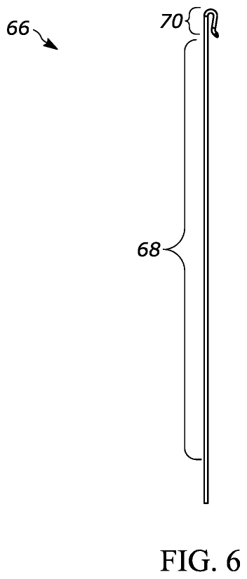

FIG. 6 shows a door frame engagement pin 66, which may be used to interconnect the front gate 13 and the side panel 8. The door frame engagement pin 66 has an elongated portion 68 and a fastening portion 70. The door frame engagement pin 66 is configured to slide into at least one side loop 64 of the door frame 9, which extend beyond the plane defined by the side panel 8. As previously mentioned, once the front gate 13 and the side panel 8 are rotated relative to one another, one or more side loop 64 on the door frame 9 extends through an opening of the side panel 8 such that the side loop 64 extends beyond the plane defined by the side panel 8. The door frame engagement pin 66 may engage (or slide through) the side loops 64 from an exterior side of the side panel 8. By this arrangement, the side loops 64 and the door frame engagement pin 66 pinche the side panel 8 against a portion of the door frame 9 so that the side panel 8 and door frame 9 are mechanically engaged in a fashion that prevents an outward rotation of the side panel.

The door frame engagement pin 66 may then retain its position on the side panel 8 by use of the fastening portion 70. In the embodiment shown, the fastening portion 70 is hook shaped and may be used to fasten the door frame engagement pin 66 into place by clipping the fastening portion 70 onto a top horizontal wire 18 of the side panel 8. In other embodiments, the fastening portion 70 may not be hook shaped, but may take on other shapes and forms. For example, the fastening portion 70 may simply be a bulbous member that will not slide through a slide loop of the door frame 9, and therefore will retain the door frame engagement pin 66 hanging in at least of the side loop 64 of the door frame 9 by preventing the door frame engagement pin 66 from falling entirely through the side loop 64.

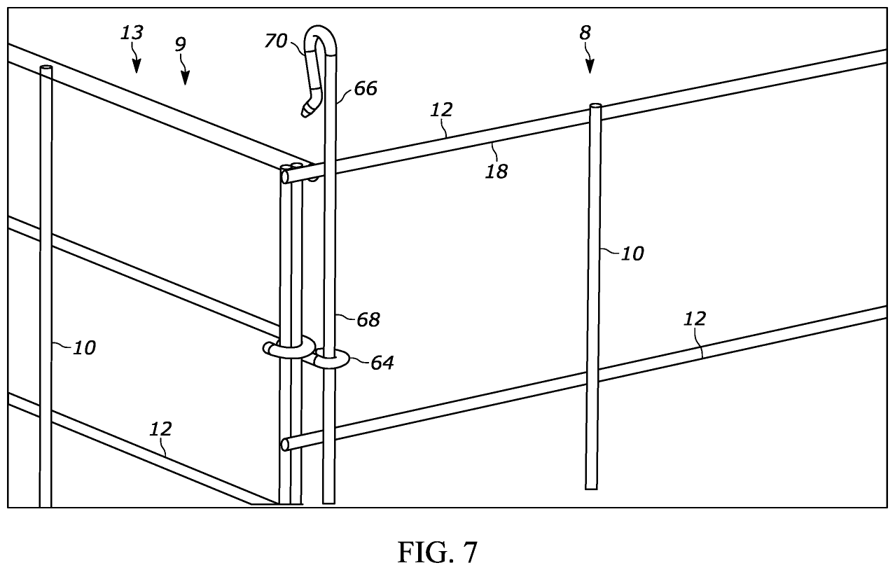

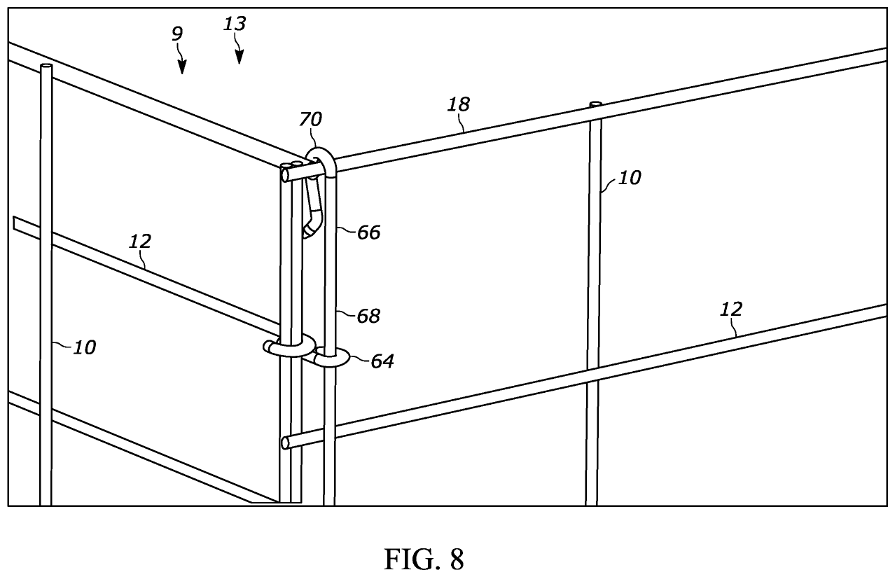

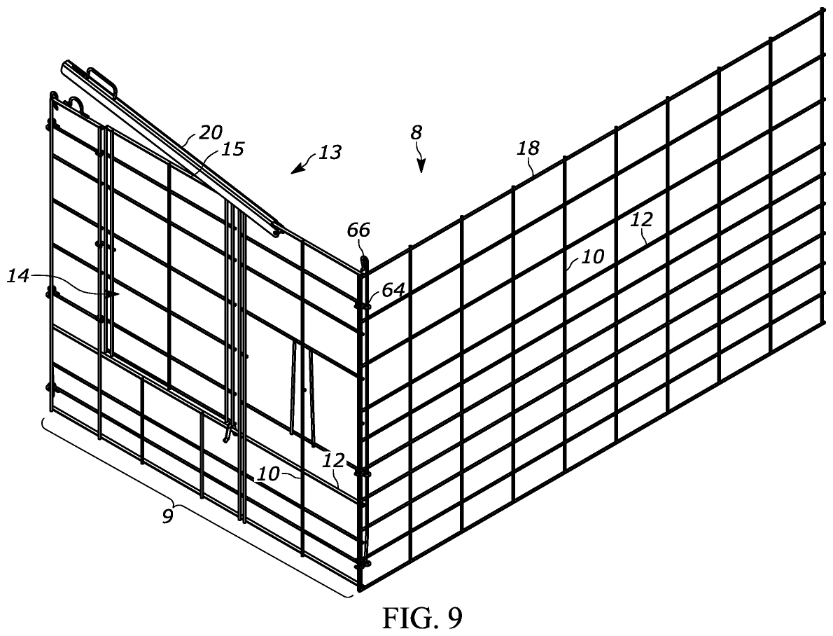

FIGS. 7-8 illustrate a door frame engagement pin 66 sliding into the side loop 64 of the door frame 9 and clipping onto a to horizontal wire 12 of the side panel 8, thereby locking the side panel 8 from rotating with respect to the door frame 9. In FIG. 7 the elongated portion 68 of the door frame engagement pin 66 is shown being slid into the side loop 64 of the door frame 9. As will be shown in FIG. 9, the elongated portion 68 of may be inserted through a plurality of side loop 64. FIG. 8 shows the fastening portion 70 (in this case a hooked portion) of the door frame engagement clipped onto the top horizontal wire 18 of the side panel 8. However, as discussed above, the fastening portion 70 of the door frame engagement pin 66 may take other forms, and retain the door frame engagement pin 66 in the side loop 64 of the door frame 9 by other means in other embodiments.

FIG. 9 shows the door 14 and door frame 9 assembly engaged to the side panel 8, the side panel 8 locked from rotating with respect to the door frame 9 by the door frame engagement pin 66. The combination of all of these elements at least partially forms a perimeter fence 6 as shown in FIG. 1.

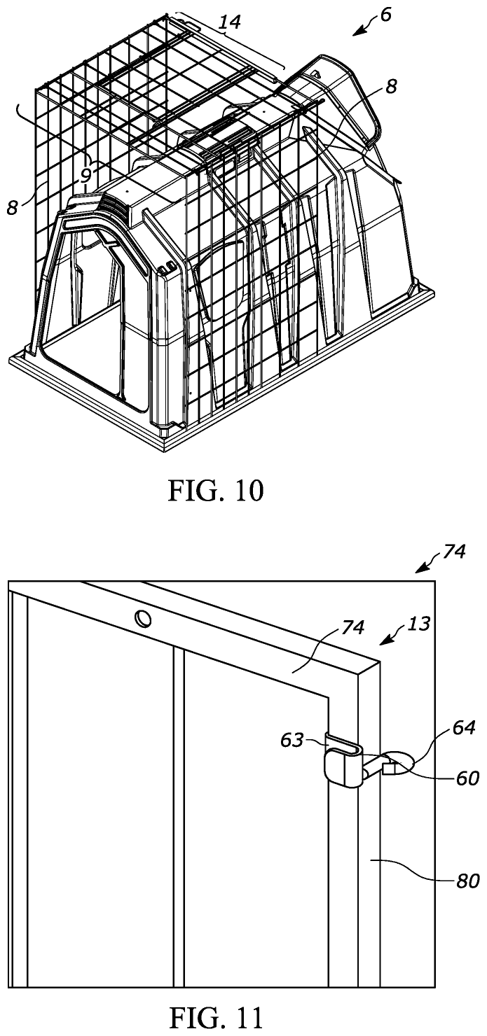

FIG. 10 illustrates the perimeter fence 6 in a transport configuration, tilted into a canopy configuration over the hutch 2. In an operational configuration, the perimeter fence sits on a ground surface in front of the hutch 2, thereby forming a yard 4, as shown in FIG. 1. In the embodiment shown, the perimeter fence is tiltably connected to the hutch 2 at the rear corners 71 so that it is tiltable between the operational configuration shown in FIG. 1 and the transport configuration shown in FIG. 10.

It should be noted that all of the linkages, hinges, latches, connections, etc. described herein are configured to hold the perimeter fence together in both the operational configuration and the transport configuration. For example, referring to FIG. 5, the side loops 64 extend through openings formed by two horizontal wires 12 in the side panels 8. Therefore, the side loops 64 limit movement (e.g., sliding movement in the vertical direction as shown in FIG. 5) of the front gate 13 relative to the side panels 8 by engaging with the horizontal wires 12, which define the upwards and downwards limits of movement. Additionally, as previously discussed, the door frame engagement pin 66 limits separation of the front gate 13 and the side panel 8 by pinching the side panel 8 between the door frame engagement pin 66 and the front gate 13.

FIGS. 11-13 illustrate another embodiment of a front gate 13 with a heavy duty door 72 and a heavy duty door frame 74. In some embodiments, the heavy duty door frame 74 may include heavy duty side hooks 62 and the side loops 64. The side hooks 62 and the side loops 64 are attached to a side framing bar 80 of the heavy duty door frame 74, and interact with the side panels 8 and the door frame engagement pin 66 in a similar fashion to that of the side hooks 62 and side loops 64 of the door frame 9. As with the side hooks 62 of the door frame 9, the heavy duty side hooks 62 also include a concave portion 60.

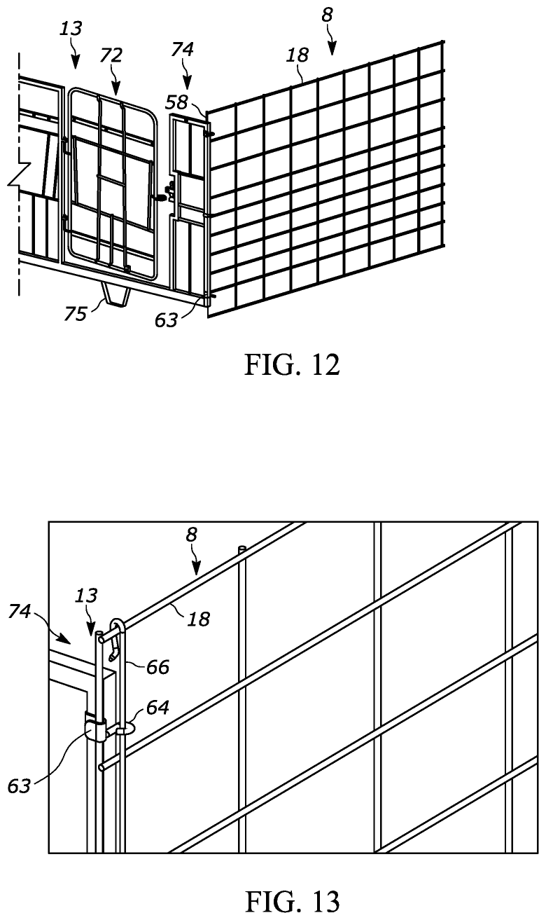

FIGS. 12-13 illustrate a side panel 8 engaging and being locked in an angular configuration with the heavy duty door 72. As shown in FIG. 12 a linking vertical wire 58 of a side panel 8 is slid into at least one heavy duty side hook 63 of the heavy duty door frame 74 such that the linking vertical wire 58 is at least partially rotatably retained in the concave portion 60 of the heavy duty side hook 63. The side panel 8 may be rotated with respect to the heavy duty door frame 74 while the linking vertical wire 58 is retained in the heavy duty side hook 63. In rotating with respect to the heavy duty door frame 74, the side panel 8 may turn about the linking vertical wire 58 as an axis of rotation. As shown in FIG. 12, the side panel 8 is rotated with respect to the heavy duty door frame 74 to a position where the side loops 64 of the heavy duty door frame 74 protrude through the fence defined by the horizontal and vertical wires 10 of the side panel 8. FIG. 13 shows a door frame engagement pin 66 slid through the side loops 64 of the heavy duty door frame 74 and fastened to the side panel 8, thereby locking the side panel 8 into a rotated position with respect to the heavy duty door frame 74.

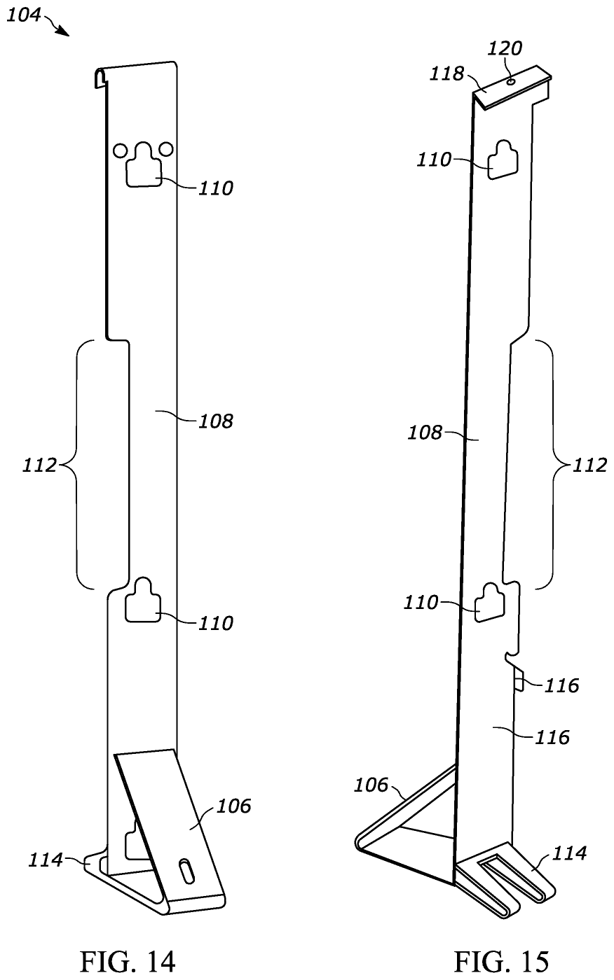

FIGS. 14-17 show a connection panel 104 used for engaging two front panels 13, or two heavy duty door frames 74, thereby connecting them in a side-by-side configuration. FIG. 14 shows the front side of the connection panel 104. As shown in FIG. 14, the connection panel 104 includes a stand portion 106 near the bottom of the connection panel 104. The stand portion 106 extends out from the body 108 of the connection panel 104 at an angle and braces the body 108 against a ground surface (not shown) upon which the connection panel 104 sits, ensuring that the body 108 stands vertically. Two apertures 110 are disposed in the body 108, and are configured to accommodate the side hooks 62, 63 of a door frame 9 or a heavy duty door frame 74. In the embodiment shown, the body 108 also includes a cutout portion 112, which provides room for accessories (e.g., buckets, bottles, etc.) to be hung on a door frame 9 or heavy duty door frame 74 engaged to the connection panel 104.

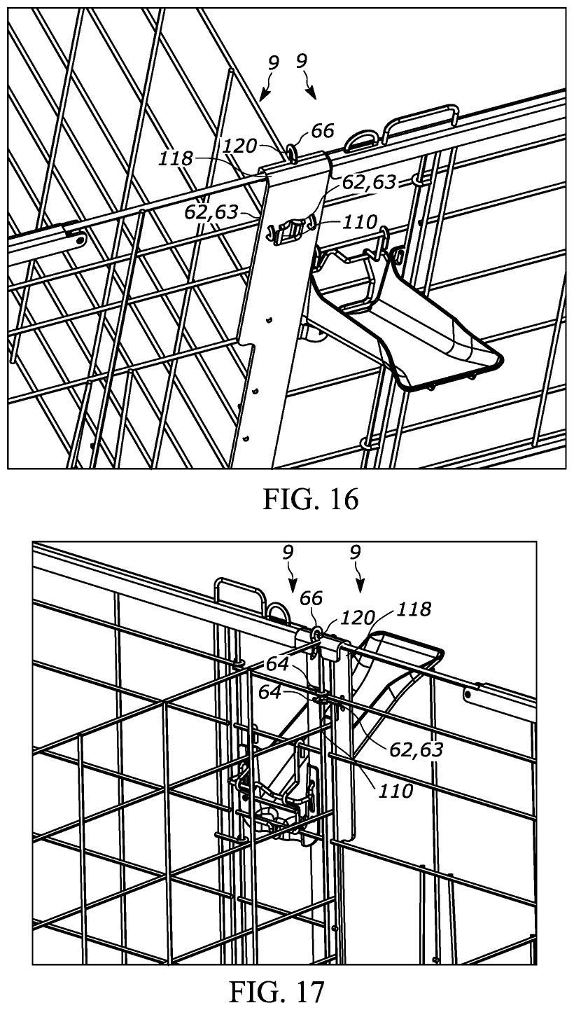

FIG. 15 shows the back side of the connection panel 104. A heel portion 114 near the bottom of the body 108 props the body 108 vertically by bracing the body 108 against a ground surface, much like the stand portion, when the engagement panel is placed on a ground surface. The heel portion 114 includes toes 115 configured to accommodate a vertical wire 10 or bar of a side panel 8. A side panel 8 placed between toes 115 is stabilized by the heel 114 and toes 115 and held standing there. The side panel 8, being held between toes 115 in such a position may be removed and replaced from that position without affecting the stabilization of the door frames 9 by the connection panel 104. Two fingers 116 are disposed on a bottom portion of the back side of the body 108, and are configured to engage a horizontal wire 12 or horizontal bar of a door frame 9 or heavy duty door frame 74 when either type of door frame is engaged to the connection panel 104, thereby adding to the stability of the door frame 9 or heavy duty door frame 74 that the fingers 116 engage. A pin engagement ridge 118 including a door frame engagement pin hole 120 is disposed at the top of the body 108 and is configured to receive a door frame engagement pin 66 through the pin hole, and to engage the fastening portion 70 of the door frame engagement pin 66, as is shown in FIGS. 16-17.

FIGS. 16-17 show two door 14 frames 9 locked into a side-by-side configuration by a connection panel 104 and an door frame engagement pin 66. As shown in FIG. 16, the side hooks 62 of two door frames 9 are inserted into a side hook aperture 110 of the connection panel 104, thereby linking the door frames 9 in a side-by-side configuration. The cutout portion 112 of the connection panel 104 ensures that the body 108 does not interfere with the accessories hanging on the door frames 9. In FIG. 17, the pin engagement ridge 118 hangs over and engages the top horizontal wires 12 of the door frames 9. The door frame engagement pin hole 120 is vertically aligned with the side loops 64 of the door frames 9 due to the side hooks 62 properly engaging the side hook apertures 110 of the body 108. The elongated portion 68 of the door frame engagement pin 66 is inserted into the door frame engagement pin hole 120 and down through the side loops 64, thereby interconnecting the door frames 9 into a side-by-side configuration. The fastening portion 70 of the door frame engagement pin 66 is pressed down onto the pin engagement ridge 118 and mechanically engages the pin engagement ridge 118, thereby removably securing the door frame engagement pin 66 in place.

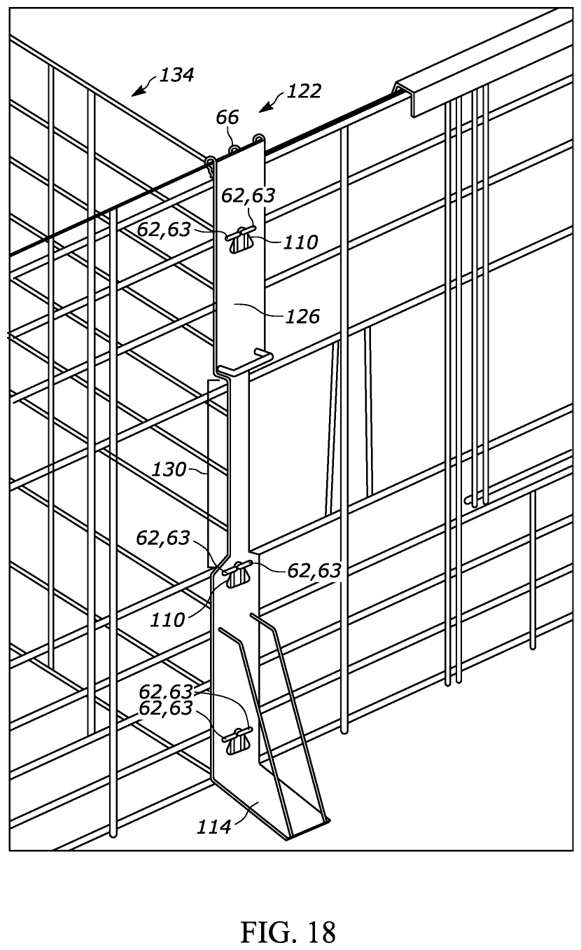

FIGS. 18-20 show a second type of connection panel 122 used for engaging two front panels 13, or two heavy duty door frames 74, to connect them in a side-by-side configuration. As shown in FIG. 18, the connection panel 122 includes a stand portion 114 near the bottom of the connection panel 122. The stand portion 114 extends out from a bottom portion of the body 126, at an angle generally perpendicular to a ground surface (not shown) upon which the connection panel 122 sits, and braces the body 126 against the ground surface, ensuring that the body 126 stands vertically. Two apertures 128 are disposed in the body 126, and are configured to accommodate the side hooks 62, 63 of a door frame 9 or a heavy duty door frame 74. In the embodiment shown, the body 126 also includes a cutout portion 130, which provides room for accessories (e.g., buckets, bottles, etc.) to be hung on a door frame 9 or heavy duty door frame 74 engaged to the connection panel 122. FIG. 18 shows two door 14 frames 9 locked into a side-by-side configuration by a connection panel 122 and an door frame engagement pin 66. As shown in FIG. 18, the side hooks 62, 63 of two door frames 9 are inserted into a side hook aperture 110 of the connection panel 122, thereby linking the door frames 9 in a side-by-side configuration. The side hook apertures 110 of the embodiment shown include a wider opening on one side of the side hook aperture 110 and a narrow opening on the other side of the aperture 110, to make insertion of the side hooks 62, 63 into the side hook apertures 110 easy. With such a side hook aperture 110 shape, the side hooks 62, 63 can easily be inserted through the bottom of the side hook aperture 110 and moved upward relative to the side hook aperture 110 to engage and be tensioned against the body 126 of the connection panel 122. The cutout portion 112 of the connection panel 104 ensures that the body 108 does not interfere with the accessories hanging on the door frames 9.

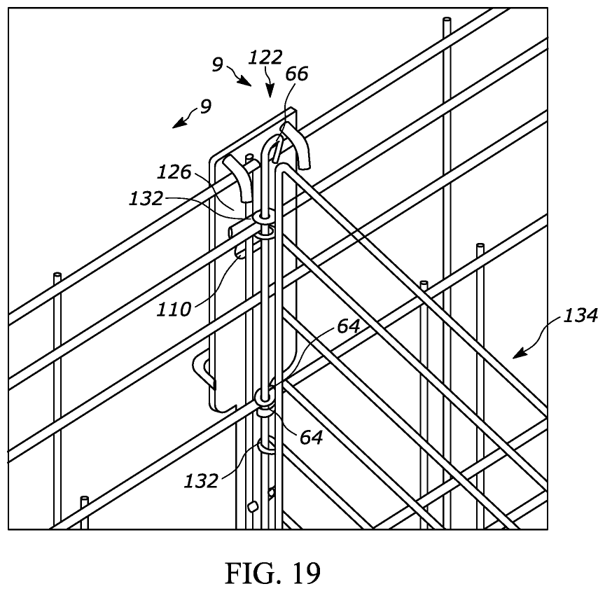

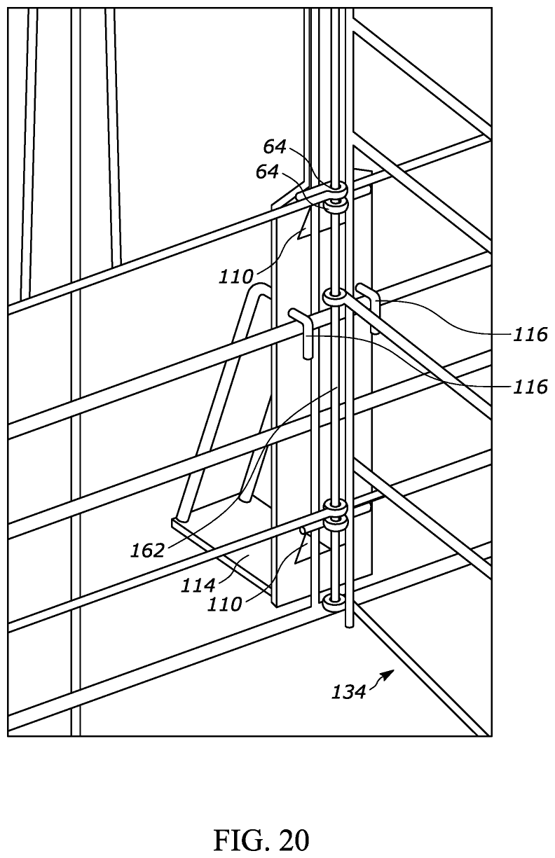

FIG. 19-20 shows the elongated portion 68 of the door frame engagement pin 66 inserted down through the side loops 64, along a back side of the connection panel 122, thereby interconnecting the door frames 9 into a side-by-side configuration held upright by the engagement of the side hooks 62 with the connection panel 122 via the side hook apertures 122 as shown in FIG. 18. Two fingers 116 are disposed on a bottom portion of the back side of the body 108, and are configured to engage a horizontal wire 12 or horizontal bar of a door frame 9 or heavy duty door frame 74 when either type of door frame is engaged to the connection panel 104, thereby adding to the stability of the door frame 9 or heavy duty door frame 74 that the fingers 116 engage. FIG. 19-20 show the side loops 64 of two different door frames 9 overlaying one another such that door frame engagement pin 66 can be inserted through the aligned side loops 64. This overlaying of the aligned side loops 64 is possible with door frames 9 of the same type, wherein the door frames 9 include a first side loop 64 disposed on a first outermost vertical wire or framing bar and disposed at a relatively higher position along the height of the first laterally outermost vertical wire or framing bar and a second side loop disposed on a second laterally outermost vertical wire or framing bar at a relatively lower position along the height of the second laterally outermost vertical wire or framing bar as compared to the height of the first side loop. FIGS. 19-20 further show that a divider panel loops 132 of a divider panel 134 may also be aligned with the side loops 64 such that door frame engagement pin 66 can be inserted down through the side loops 64 and the divider panel loops 132, along a back side of the connection panel 122. A fore portion of the divider panel 134 may be held in mechanical engagement with the door frames 9 and the connection panel 122, while an aft portion of the divider panel 134 is braced between two hutches 2. In this arrangement, the divider panel 134 is braced between the two hutches and held in a perpendicular arrangement to the door frames 9 by its interaction with the door frame engagement pin 66. When installed in this way, the divider panel 134 can be used to separate the yards 4 of two adjacent hutches 2, but can be removed to connect the yards 4 without significantly compromising the stability of the door frame 9 interconnected by the connection panel 122. Specifically, door frame engagement pin 66 can be removed from the side loops 64 and the divider panel loops 132, and the divider panel 134 may be removed. When the door frame engagement pin 66 is removed, the door frames 9 will stay interconnected in a side-by-side configuration due to their interaction with the connection panel 122 and fingers 116. After the removal of the door frame engagement pin 66 and the divider panel 134, the door frame engagement pin 66 may be inserted back through the side loops 64 to further reinforce the engagement between the door frames 9 and the connection panel 122.

The embodiment described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention. Various features and advantages of the invention are set forth in the following claims.

What is claimed is:

1. A method of assembling a fence unit, the method comprising:
providing a side panel and a door frame of a fence assembly, the side panel including a plurality of vertical wires and a plurality of horizontal wires, the door frame including a side hook and side loop;
sliding one of the plurality of vertical wires of the side into the side hook of the door frame;
rotating the side panel with respect to the door frame such that the side loop of the door frame protrudes through a plane defined by the side panel; and
inserting a door frame engagement pin through the side loop, the door frame engagement pin including an elongated portion and a fastening portion, wherein, once inserted, the elongated portion engages at least one of the plurality of horizontal wires of the side panel to prevent the side panel from rotating with respect to the door frame.

2. The method of claim 1, further including pressing the door frame engagement pin down over a pin engagement ridge to removably secure the door frame engagement pin in place.

3. The method of claim 1, wherein rotating the side panel includes rotating the side panel until the side panel is positioned perpendicular to the door frame.

4. The method of claim 3, wherein rotation of the side panel is limited by engagement between the horizontal wires of the side panel and a vertical wire or framing bar of the door frame.

5. A front gate for a modular animal enclosure comprising:
a door frame including a first laterally outermost vertical wire or framing bar;
a door disposed in the door frame;
a first set of one or more side hooks disposed on the first laterally outermost vertical wire or framing bar; and
a first set of one or more side loops disposed on the first laterally outermost vertical wire or framing bar,
wherein the first set of one or more side hooks are configured to engage a linking vertical wire of a side panel, the side panel including a plurality of horizontal wires and plurality of vertical wires, and
wherein the first set side loops are configured to protrude through a plane defined by the plurality of horizontal wires and plurality of vertical wires.

6. The front gate of claim 5, wherein the first set of one or more side loops are configured to receive a door frame engagement pin inserted therethrough.

7. The front gate of claim 6, wherein the first set of one or more side loops are configured to prevent an outward rotation of the side panel by pinching the side panel against a portion of the door frame via the door frame engagement pin.

8. The front gate of claim 7, wherein the door frame includes a second laterally outermost vertical wire or framing bar, wherein a second set of one or more side hooks and a second set of one or more side loops are disposed on the second laterally outermost vertical wire or framing bar.

9. The front gate of claim 8, wherein the first and second laterally outermost vertical wire or framing bar are the same height, and
wherein the second set of one or more side loops disposed on the second laterally outermost vertical wire or framing bar are disposed at a relatively higher position along the height of the second laterally outermost vertical wire or framing bar while the first set of one or more side loops disposed on the first laterally outermost vertical wire or framing bar are disposed at a relatively lower position along the height of the first laterally outermost vertical wire or framing bar.

10. The front gate of claim 5, wherein the door frame is configured to be linked to a second door frame having a second set of one or more side loops, wherein, when the door frame and the second door frame are linked,
the first set of one or more side loops overlaps the second set of one or more side loops, and
a door frame engagement pin extends through the first set of one or more side loops and the second set of one or more side loops.

11. The front gate of claim 5, wherein the side loops are configured to protrude through the plane defined by the plurality of horizontal wires and plurality of vertical wires when the side panel is oriented perpendicular to the door frame.

12. The front gate of claim 5, wherein the vertical wire or framing bar of the door frame is configured to limit rotation of the side panel by engaging one or more horizontal wire of the side panel.

13. A connection panel configured to connect a first door frame and a second door frame, the connection panel comprising:
a body;
a side hook aperture disposed in the body and configured to accommodate a side hook of a door frame;
a stand portion disposed proximate the bottom of the body and extending therefrom, the stand portion configured to support the body in a vertical orientation relative to a ground surface; and
at least one finger disposed on a back side of the body, the finger configured to engage a horizontal wire or a horizontal bar of the door frame.

14. The connection panel of claim 13, wherein the side hook aperture is configured to align a first side loop of a first door frame and a second side loop of a second door frame to allow a door frame engagement pin to be inserted through the first side loop and the second side loop.

15. The connection panel of claim 14, wherein the connection panel is confirmed to support the first door frame and the second door frame along the same plane as one another.

16. The connection panel of claim 13, wherein the stand portion extends from the body at a declined angle with respect to the ground surface

17. The connection panel of claim 13, further comprising a heel portion positioned proximate the bottom of the body, the heel portion configured to prop the body vertically by bracing the body against a ground surface as an engagement panel sits on a ground surface; and,

18. The connection panel of claim 13, further comprising a pin engagement ridge including a door frame engagement pin hole disposed along the top of the body, the pin engagement ridge configured to receive a door frame engagement pin through the door frame engagement pin hole and to engage the fastening portion of the door frame engagement pin.

19. The connection panel of claim 13, wherein the pin engagement ridge is configured to receive a fastening portion of the door frame engagement pin.

20. The connection panel of claim 13, wherein the side hook aperture includes a top portion and a bottom portion, wherein the top portion is narrower than the bottom portion.
